(19) United States
(12) Patent Application Publication
(10) Pub. No.: US 2022/0406530 A1
(43) Pub. Date: Dec. 22, 2022

(54) THIN FILM CAPACITOR AND ELECTRONIC CIRCUIT MODULE HAVING THE SAME

(71) Applicant: TDK Corporation, Tokyo (JP)

(72) Inventors: Daiki ISHII, Tokyo (JP); Eiko TAMURA, Tokyo (JP)

(21) Appl. No.: 17/777,515

(22) PCT Filed: Mar. 22, 2021
(86) PCT No.: PCT/JP2021/011668

§ 371 Date: May 17, 2022

Related U.S. Application Data
(60) Provisional application No. 62/993,338, filed on Mar. 23, 2020.

(51) Int. Cl. H01G 4/33; H01G 4/012; H01G 4/232; H01G 2/06

(52) U.S. Cl. CPC H01G 4/33; H01G 4/012; H01G 4/232; H01G 2/065

(57) ABSTRACT

To provide a thin film capacitor capable of achieving low impedance over a wide frequency band. A thin film capacitor includes: a capacitor layer having a structure in which internal electrode layers and dielectric layers are alternately stacked; a redistribution layer stacked on the capacitor layer; and external terminals. The redistribution layer includes a wiring pattern connecting the external terminal and the internal electrode layers and a wiring pattern connecting the external terminal and the internal electrode layers. A distance between first and second via conductors is smaller than distance between second and third via conductors and is smaller than a distance between first and fourth via conductors.

### TECHNICAL FIELD

The present invention relates to a thin film capacitor and an electronic circuit module having the same.

### BACKGROUND ART

A thin film capacitor has a structure in which a plurality of internal electrode layers and a plurality of dielectric layers are alternately stacked. Odd-numbered ones of the plurality of internal electric layers are connected in common to a first external terminal through a first wiring pattern included in a redistribution layer, and even-numbered ones of the plurality of internal electric layers are connected in common to a second external terminal through a second wiring pattern included in the redistribution layer. As a result, a plurality of unit capacitors are connected in parallel between the first and second external terminals.

### CITATION LIST

### Patent Document

[Patent Document 1] JP 2018-206839A

### SUMMARY OF THE INVENTION

### Problem to be Solved by the Invention

Conventional thin film capacitors have difficulty in achieving low impedance over a wide frequency band.

It is therefore an object of the present invention to provide an improved thin film capacitor.

### Means for Solving the Problem

A thin film capacitor according to the present invention comprises: a capacitor layer having a structure in which a plurality of internal electrode layers and a plurality of dielectric layers are alternately stacked; a redistribution layer stacked on the capacitor layer; and first and second external terminals, wherein the plurality of internal electrode layers include a plurality of odd-numbered electrode layers including at least first and third internal electrode layers and a plurality of even-numbered electrode layers including at least second and fourth internal electrode layers, wherein the first, second, third, and fourth internal electrode layers are stacked in this order through the plurality of dielectric layers, wherein the redistribution layer includes a first wiring pattern connecting the first external terminal and the odd-numbered electrode layers and a second wiring pattern connecting the second external terminal and the even-numbered electrode layers, wherein the first and third internal electrode layers are connected to the first wiring pattern respectively through first and third via conductors, wherein the second and fourth internal electrode layers are connected to the second wiring pattern respectively through second and fourth via conductors, and wherein a distance between the first and second via conductors is smaller than a distance between the second and third via conductors and is smaller than a distance between the first and fourth via conductors.

### Advantageous Effects of the Invention

According to the present invention, a plurality of capacitors having mutually different self-resonance frequencies are connected in parallel, so that low impedance can be achieved over a wide frequency band.

### BRIEF DESCRIPTION OF THE DRAWINGS

FIG. 1 is a schematic cross-sectional view of a thin film capacitor according to a first embodiment.

FIG. 2 is an equivalent circuit diagram of the thin film capacitor illustrated in FIG. 1.

FIG. 3 is a circuit diagram of an electronic circuit module having the thin film capacitor illustrated in FIG. 1.

FIG. 4A is a schematic cross-sectional view of a thin film capacitor according to a second embodiment.

FIG. 4B is a schematic cross-sectional view of a thin film capacitor according to a first modification of the second embodiment.

FIG. 4C is a schematic cross-sectional view of a thin film capacitor according to a second modification of the second embodiment.

FIG. 5A is a schematic cross-sectional view of a thin film capacitor according to a third embodiment.

FIG. 5B is a schematic cross-sectional view of a thin film capacitor according to a first modification of the third embodiment.

FIG. 5C is a schematic cross-sectional view of a thin film capacitor according to a second modification of the third embodiment.

FIG. 6 is a schematic cross-sectional view of a thin film capacitor according to a fourth embodiment.

FIG. 7 is a schematic cross-sectional view of a thin film capacitor according to a fifth embodiment.

FIG. 8 is a schematic cross-sectional view of a thin film capacitor according to a sixth embodiment.

FIG. 9 is a schematic cross-sectional view of a thin film capacitor according to a seventh embodiment.

FIG. 10 is a schematic cross-sectional view of a thin film capacitor according to an eighth embodiment.

FIG. 11 is a schematic cross-sectional view of a thin film capacitor according to a ninth embodiment.

FIG. 12 is a table for indicating simulation results of Examples.

### MODE FOR CARRYING OUT THE INVENTION

Hereinafter, preferred embodiments of the present invention will be described in detail with reference to the accompanying drawings. Positional relationships such as upper, lower, left, and right will be based on positional relationships represented in the drawings unless otherwise specified. Further, ratios of dimensions in the drawings are not limited to those depicted. Further, the embodiments described hereinafter are illustrative and do not limit the present invention to the embodiments. Further, various modifications can be made without departing from the spirit of the present invention.

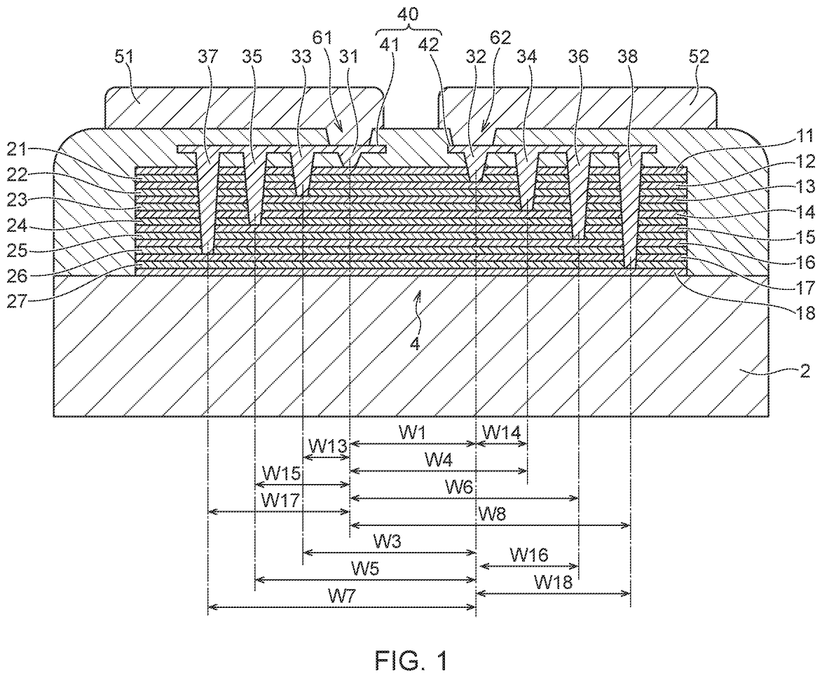

FIG. 1 is a schematic cross-sectional view of a thin film capacitor according to a first embodiment. The thin film capacitor illustrated in FIG. 1 includes a capacitor layer 4 having a structure in which internal electrode layers 11 to 18 and dielectric layers 21 to 27 are alternately stacked on a substrate 2, a redistribution layer 40 stacked on the capacitor layer 4, and external terminals 51 and 52. The redistribution layer 40 has wiring patterns 41 and 42. The odd-numbered internal electrode layers 11, 13, 15, and 17 are connected to the wiring pattern 41 respectively through via conductors 31, 33, 35, and 37. The even-numbered internal electrode layers 12, 14, 16, and 18 are connected to the wiring pattern 42 respectively through via conductors 32, 34, 36, and 38. The wiring patterns 41 and 41 are connected to the external terminals 51 and 52 respectively through via conductors 61 and 62.

Assuming that the distances from the via conductor 31 to the via conductors 32, 34, 36, and 38 are W1, W4, W6, and W8, respectively, and that the distances from the via conductor 32 to the via conductors 31, 33, 35, and 37 are W1, W3, W5, and W7, respectively, relations, W1<W3, W4<W5, and W6<W7, W8, are satisfied. Further, assuming that the distances from the via conductor 61 to the via conductors 31, 33, 35, and 37 are W1, W13, W15, and W17, respectively, W11<W13<W15<W17 is satisfied. Further, assuming that the distances from the via conductor 62 to the via conductors 32, 34, 36, and 38 are W12, W14, W16, and W18, respectively, W12<W14<W16<W18 is satisfied. In the example illustrated in FIGS. 1, W11 and W12 are each zero.

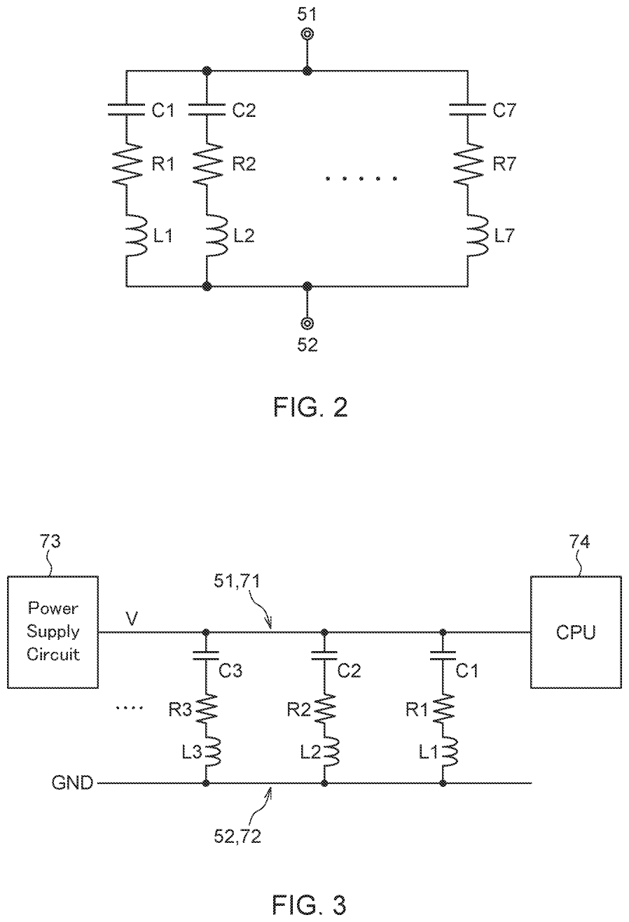

FIG. 2 is an equivalent circuit diagram of the thin film capacitor illustrated in FIG. 1. Assuming that capacitors constituted by pairs of internal electrode layers sandwiching the dielectric layers 21 to 27 are C1 to C7, respectively, the capacitors C1 to C7 are connected in parallel between the external terminals 51 and 52. The capacitors C1 to C7 are added in series with parasitic resistances R1 to R7 and parasitic inductances L1 to L7, respectively.

FIG. 3 is a circuit diagram of an electronic circuit module having the thin film capacitor illustrated in FIG. 1. As illustrated in FIG. 3, the external terminal 51 is connected to a power supply line 71, and the external terminal 52 is connected to a ground line 72. The power supply line 71 is applied with a power supply potential V from a power supply circuit 73. The ground line 72 is applied with a ground potential GND. The power supply line 71 is connected to a CPU 74.

The power supply line 71 and the ground line 72 are connected to the internal electrode layers 11 and 12 constituting the capacitor C1 respectively through the via conductors 31 and 32. The distance W1 between the via conductors 31 and 32 is smaller than the distances W3 to W8 between the other via conductors, so that the parasitic inductance L1 added to the capacitor C1 is smaller than the other parasitic inductances L2 to L7. Thus, the capacitor C1 has a high self-resonant frequency. On the other hand, the parasitic inductances L2 to L7 added respectively to the other capacitors C2 to C7 are larger than the parasitic inductance L1. Thus, the capacitors C2 to C7 have a self-resonant frequency lower than that of the capacitor C1. Assuming that the self-resonant frequencies of the capacitors C1 to C7 are SRF1 to SRF7, respectively, a relation, SRF1>SRF2>SRF3>SRF4>SRF5 >SRF6>SRF7, is satisfied.

As described above, in the present embodiment, a plurality of capacitors C1 to C7 having mutually different self-resonant frequencies are connected in parallel, thus making it possible to achieve low impedance over a wide frequency band. Typical circuit modules achieve low impedance over a wide frequency band by connecting in parallel a plurality of capacitor devices having mutually different self-resonant frequencies, while in the present embodiment, this can be achieved by a single thin film capacitor.

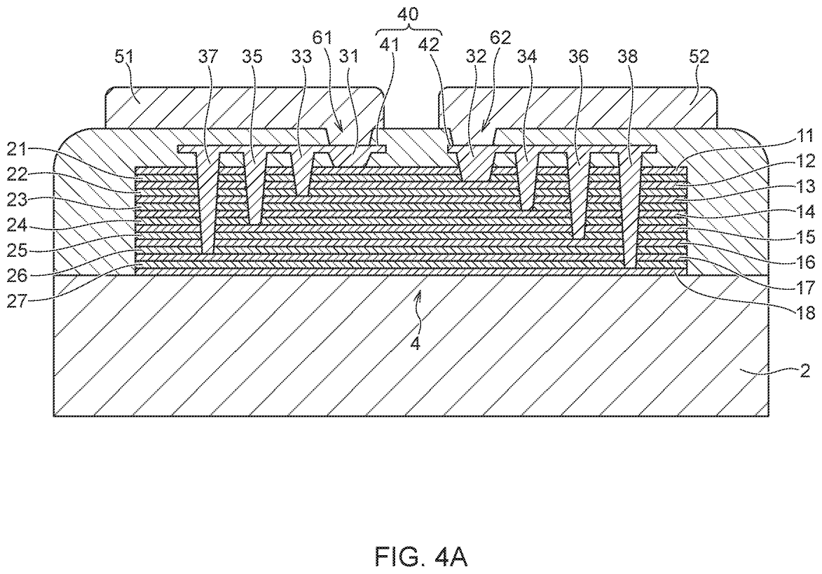

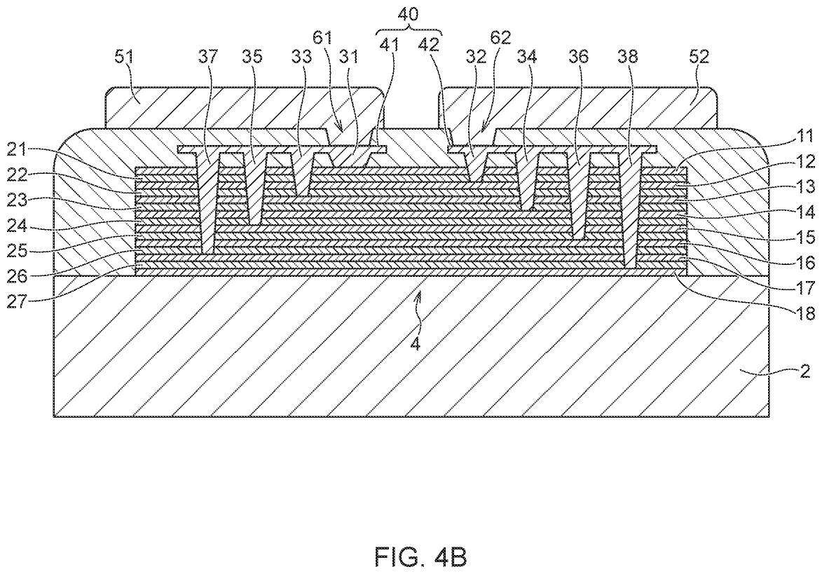

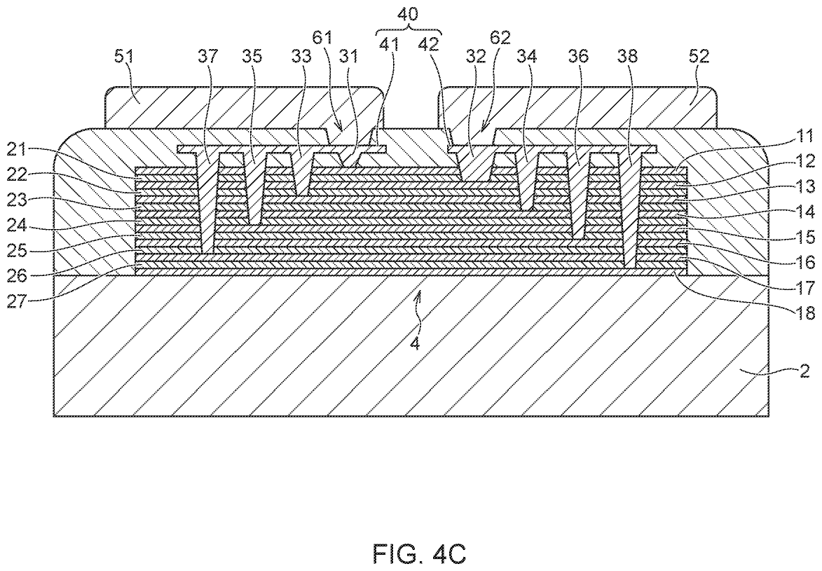

A thin film capacitor according to a second embodiment illustrated in FIG. 4A is featured in that the diameters of the via conductors 31 and 32 are larger than those of the other via conductors 33 to 38. This further reduces the parasitic inductance L1 to further increase the self-resonant frequency SRF1 of the capacitor C1. A thin film capacitor illustrated in FIG. 4B is featured in that the diameter of the via conductor 31 is larger than those of the other via conductors 32 to 38. A thin film capacitor illustrated in FIG. 4C is featured in that the diameter of the via conductor 32 is larger than those of the other via conductors 31 and 33 to 38. Thus, the diameter of only one of the via conductors 31 and 32 may be enlarged so as to reduce the parasitic inductance L1.

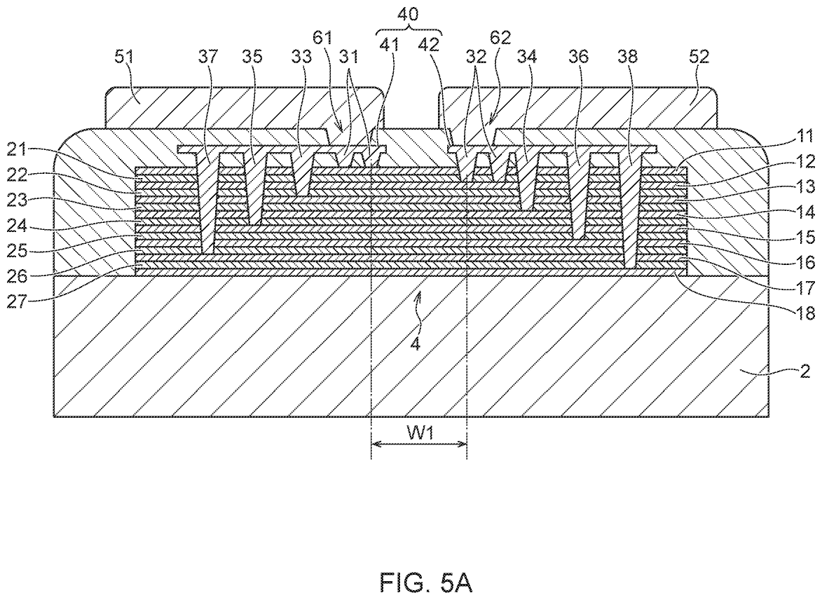

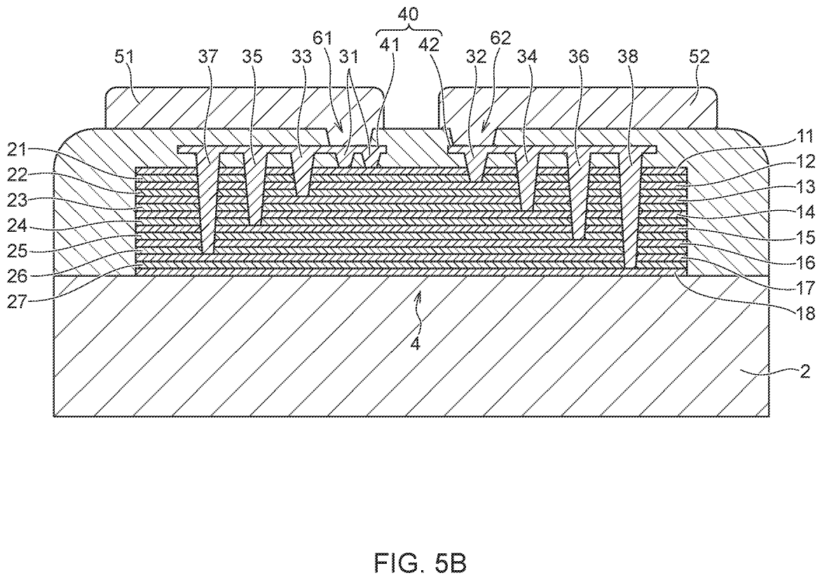

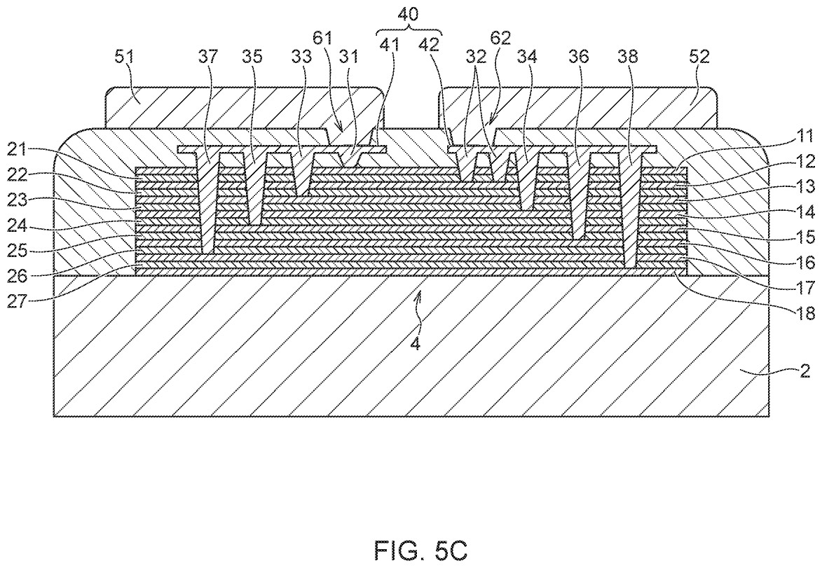

A thin film capacitor according to a third embodiment illustrated in FIG. 5A is featured in that the number of each of the via conductors 31 and 32 is two, while the number of each of the other via conductors 33 to 38 is one. This further reduces the parasitic inductance L1 and hence increases the self-resonant frequency SRF1 of the capacitor C1. When the number of each of the via conductors 31 and 32 is two or more as illustrated in FIG. 5A, the distance W1 between the via conductors 31 and 32 is defined by the distance between the via conductors 31 and 32 which are situated closest to each other. A thin film capacitor illustrated in FIG. 5B is featured in that the number of the via conductors 31 is two, while the number of each of the other via conductors 32 to 38 is one. A thin film capacitor illustrated in FIG. 5C is featured in that the number of the via conductors 32 is two, while the number of each of the other via conductors 31 and 33 to 38 is one. Thus, the number of only one of the via conductors 31 and may be increased so as to reduce the parasitic inductance L1.

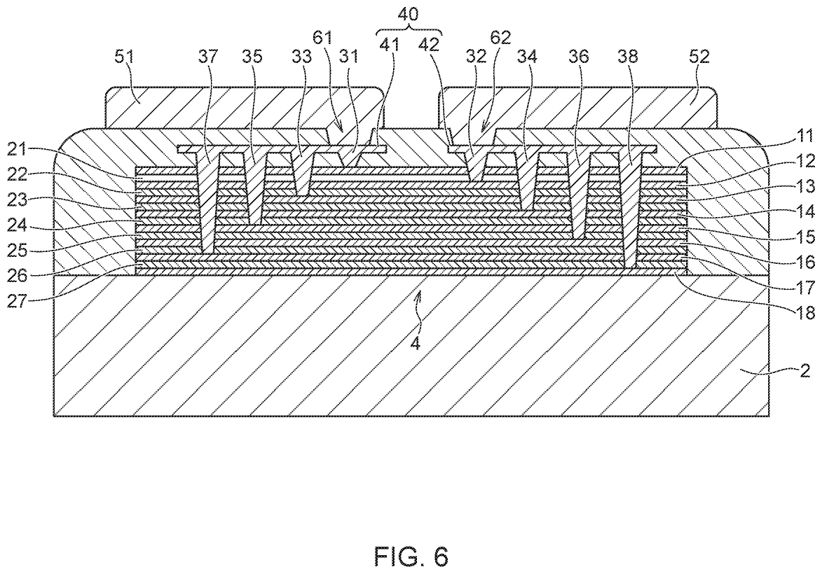

A thin film capacitor according to a fourth embodiment illustrated in FIG. 6 is featured in that the dielectric constant of the dielectric layer 21 is lower than those of the other dielectric layers 22 to 27. This reduces the capacitance of the capacitor C1 and hence increases the self-resonant frequency SRF1 of the capacitor C1.

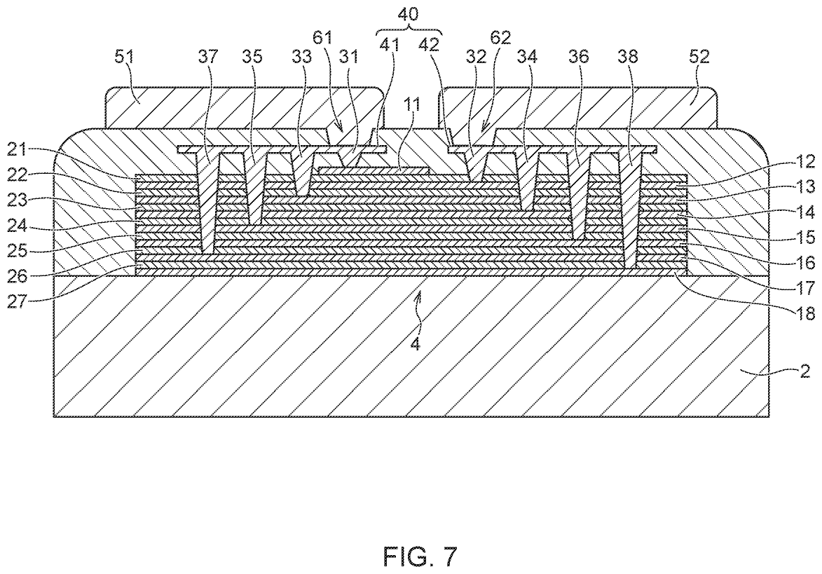

A thin film capacitor according to a fifth embodiment illustrated in FIG. 7 is featured in that the outer size of the internal electrode layer 11 is smaller than those of the other internal electrode layers 12 to 18. This reduces the capacitance of the capacitor C1 to further increase the self-resonant frequency SRF1 of the capacitor C1.

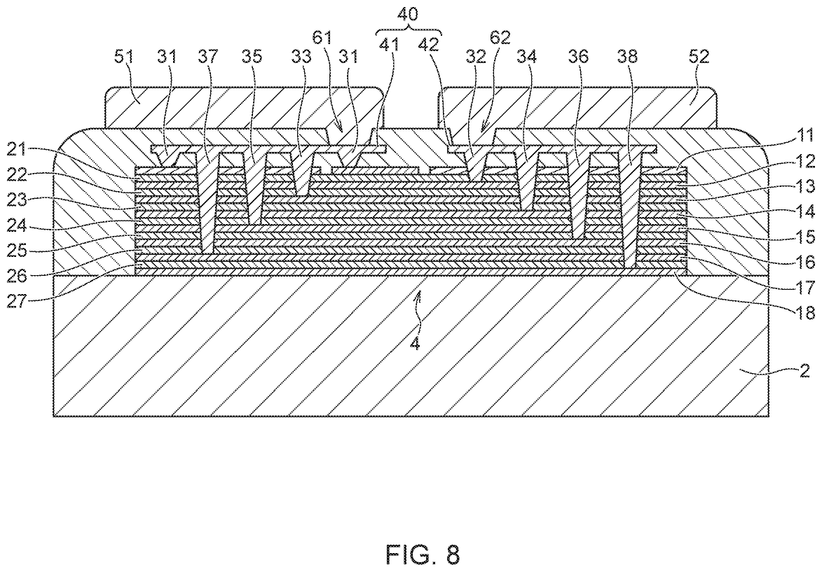

A thin film capacitor according to a sixth embodiment illustrated in FIG. 8 is featured in that the internal electrode layer 11 is divided into a plurality of areas, and the via conductors 31 are assigned to the respective areas. It follows that the capacitor C1 is divided into a plurality of capacitors mutually connected in parallel, further increasing the self-resonant frequency SRF1 of the capacitor C1.

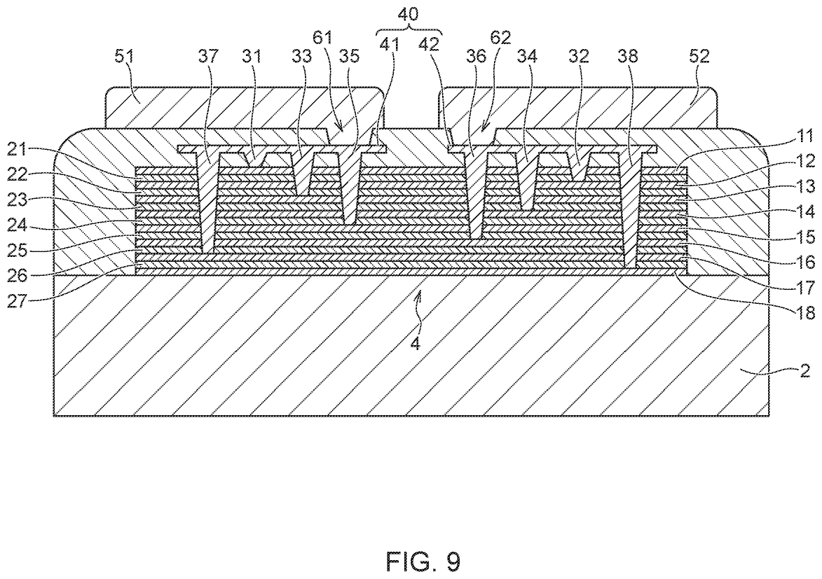

A thin film capacitor according to a seventh embodiment illustrated in FIG. 9 is featured in that the positions of the via conductors 31 and 35 are interchanged, and the positions of the via conductors 32 and 36 are interchanged. This further reduces the parasitic inductance L4 due to a magnetic field cancelling effect to further increase the self-resonant frequency SRF4 of the capacitor C4.

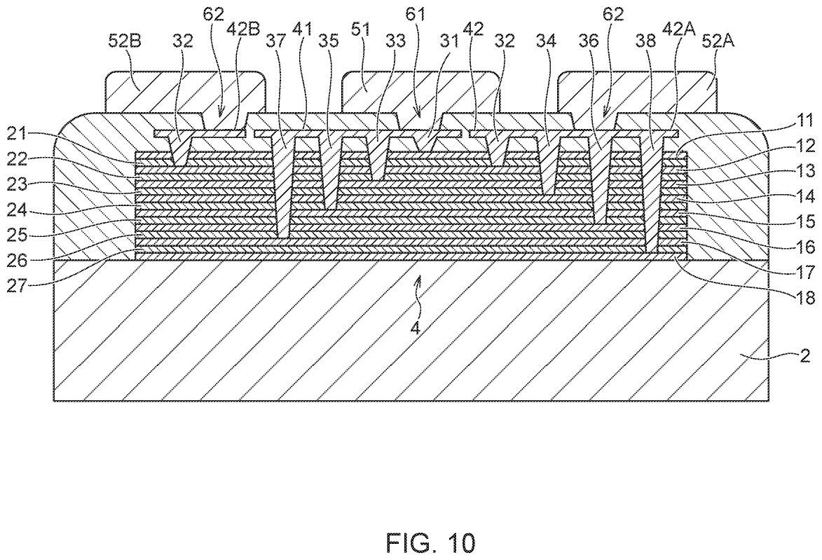

A thin film capacitor according to an eighth embodiment illustrated in FIG. 10 is featured in that the wiring pattern 42 is divided into two wiring patterns 42A and 42B, and the external terminals 52A and 52B are assigned respectively to the wiring patterns 42A and 42B. As described above, a plurality of external terminals applied with the same potential may be provided.

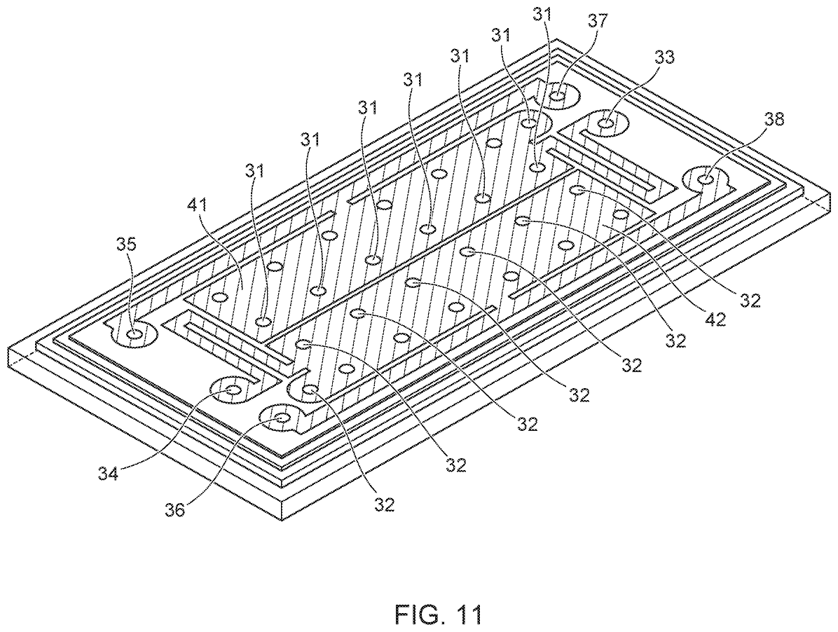

In a thin film capacitor according to a ninth embodiment illustrated in FIG. 11, a connection part of the wiring pattern 41 that is connected to the via conductor 31 and a connection part thereof that is connected to each of the via conductors 33, 35, and 37 are not mutually connected through a shortest route but connected through a detouring part. Similarly, a connection part of the wiring pattern 42 that is connected to the via conductor 32 and a connection part thereof that is connected to each of the via conductors 34, 36, and 38 are not mutually connected through a shortest route but connected through a detouring part. The detouring parts may have a meander shape. This further increases the parasitic inductances L2 to L7 and hence reduces the self-resonant frequencies SRF2 to SRF7 of the capacitors C2 to C7. In the example illustrated in FIG. 11, the via conductors 31 and 32 are each provided in multiple numbers.

While the preferred embodiment of the present disclosure has been described, the present disclosure is not limited to the above embodiment, and various modifications may be made within the scope of the present disclosure, and all such modifications are included in the present disclosure.

### Examples

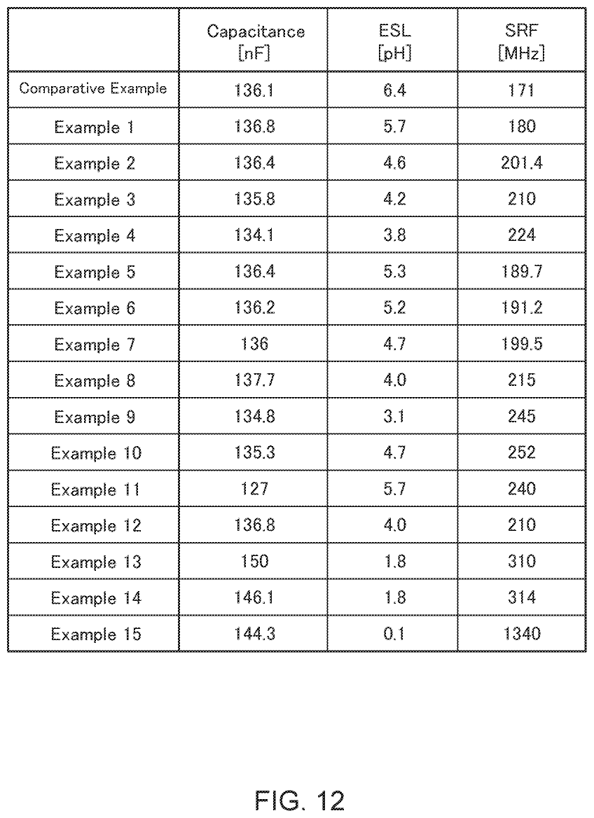

There was assumed a thin film capacitor of Example 1 having the structure illustrated in FIG. 1, and the capacitance, ESL, and self-resonant frequency thereof were calculated by simulations. The planar size of the thin film capacitor was 1 mm×0.5 mm. The areas of the internal electrode layers 11 to 18 were 0.334 mm², 0.347 mm², 0.360 mm², 0.373 mm², 0.386 mm², 0.400 mm², 0.414 mm², and 0.428 mm², respectively. The dielectric constant ε of the dielectric layers 21 to 27 was 1000. The diameter of the via conductors 31 to 38 was 30 μm. The distance W1 was 100 μm, the distances W3 and W4 were 141.42 μm, the distances W5 and W6 were 223.61 μm, the distances W7 and W8 were 316.23 μm, and the distances W11 to 18 were 100 μm. The distance between the external terminals 51 and 52 was 30 μm. As shown in FIG. 12, the capacitance of the thin film capacitor of Example 1 was 136.8 nF, the ESL thereof was 5.7 pH, and the self-resonant frequency thereof was 180 MHz.

Then, there was assumed a thin film capacitor of a comparative example having the same conditions as those of Example 1 except that the distance W1 was set to 141.42 μm, the distance W4 to 316.23 μm, and the distances W7 and W8 to 100 μm, and simulations were performed. As a result, as shown in FIG. 12, the capacitance of the thin film capacitor of the comparative example was 136.1 nF, the ESL thereof was 6.4 pH, and the self-resonant frequency thereof was 171 MHz. Thus, it was confirmed that the thin film capacitor of Example 1 was smaller in ESL and higher in self-resonant frequency than the thin film capacitor of the comparative example.

There was assumed a thin film capacitor of Example 2 having the structure illustrated in FIG. 4B, and the capacitance, ESL, and self-resonant frequency thereof were calculated by simulations. The parameters were the same as those of the thin film capacitor of Example 1 except that the diameter of the via conductor 31 was enlarged. The diameter of the via conductor 31 was 60 μm. As shown in FIG. 12, the capacitance of the thin film capacitor of Example 2 was 136.4 nF, the ESL thereof was 4.6 pH, and the self-resonant frequency thereof was 201.4 MHz. Thus, the thin film capacitor of Example 2 was smaller in ESL and higher in self-resonant frequency than the thin film capacitor of Example 1.

There was assumed a thin film capacitor of Example 3 having the structure illustrated in FIG. 4C, and the capacitance, ESL, and self-resonant frequency thereof were calculated by simulations. The parameters were the same as those of the thin film capacitor of Example 1 except that the diameter of the via conductor 32 was enlarged. The diameter of the via conductor 32 was 60 μm. As shown in FIG. 12, the capacitance of the thin film capacitor of Example 3 was 135.8 nF, the ESL thereof was 4.2 pH, and the self-resonant frequency thereof was 210 MHz. Thus, the thin film capacitor of Example 3 was smaller in ESL and higher in self-resonant frequency than the thin film capacitor of Example 1.

There was assumed a thin film capacitor of Example 4 having the structure illustrated in FIG. 4A, and the capacitance, ESL, and self-resonant frequency thereof were calculated by simulations. The parameters were the same as those of the thin film capacitor of Example 1 except that the diameter of the via conductors 31 and 32 was enlarged. The diameter of the via conductors 31 and 32 was 60 μm. As shown in FIG. 12, the capacitance of the thin film capacitor of Example 4 was 134.1 nF, the ESL thereof was 3.8 pH, and the self-resonant frequency thereof was 224 MHz. Thus, the thin film capacitor of Example 4 was smaller in ESL and higher in self-resonant frequency than the thin film capacitors of Examples 2 and 3.

There was assumed a thin film capacitor of Example 5 having the structure illustrated in FIG. 5B, and the capacitance, ESL, and self-resonant frequency thereof were calculated by simulations. The parameters were the same as those of the thin film capacitor of Example 1 except that the number of the via conductors 31 was two. As shown in FIG. 12, the capacitance of the thin film capacitor of Example 5 was 136.4 nF, the ESL thereof was 5.3 pH, and the self-resonant frequency thereof was 189.7 MHz. Thus, the thin film capacitor of Example 5 was smaller in ESL and higher in self-resonant frequency than the thin film capacitor of Example 1.

There was assumed a thin film capacitor of Example 6 having the structure illustrated in FIG. 5C, and the capacitance, ESL, and self-resonant frequency thereof were calculated by simulations. The parameters were the same as those of the thin film capacitor of Example 1 except that the number of the via conductors 32 was two. As shown in FIG. 12, the capacitance of the thin film capacitor of Example 6 was 136.2 nF, the ESL thereof was 5.2 pH, and the self-resonant frequency thereof was 191.2 MHz. Thus, the thin film capacitor of Example 6 was smaller in ESL and higher in self-resonant frequency than the thin film capacitor of Example 1.

There was assumed a thin film capacitor of Example 7 having the structure illustrated in FIG. 5A, and the capacitance, ESL, and self-resonant frequency thereof were calculated by simulations. The parameters were the same as those of the thin film capacitor of Example 1 except that the numbers of the via conductors 31 and 32 were each two. As shown in FIG. 12, the capacitance of the thin film capacitor of Example 7 was 136 nF, the ESL thereof was 4.7 pH, and the self-resonant frequency thereof was 199.5 MHz. Thus, the thin film capacitor of Example 7 was smaller in ESL and higher in self-resonant frequency than the thin film capacitors of Examples 5 and 6.

There was assumed a thin film capacitor of Example 8 in which the numbers of the via conductors 31 and 32 were each three, and the capacitance, ESL, and self-resonant frequency thereof were calculated by simulations. The other parameters were the same as those of the thin film capacitor of Example 1. As shown in FIG. 12, the capacitance of the thin film capacitor of Example 8 was 137.7 nF, the ESL thereof was 4 pH, and the self-resonant frequency thereof was 215 MHz. Thus, the thin film capacitor of Example 8 was smaller in ESL and higher in self-resonant frequency than the thin film capacitor of Example 7.

There was assumed a thin film capacitor of Example 9 in which the numbers of the via conductors 31 and 32 were each four, and the capacitance, ESL, and self-resonant frequency thereof were calculated by simulations. The other parameters were the same as those of the thin film capacitor of Example 1. As shown in FIG. 12, the capacitance of the thin film capacitor of Example 9 was 134.8 nF, the ESL thereof was 3.1 pH, and the self-resonant frequency thereof was 245 MHz. Thus, the thin film capacitor of Example 9 was smaller in ESL and higher in self-resonant frequency than the thin film capacitor of Example 8.

There was assumed a thin film capacitor of Example having the structure illustrated in FIG. 8, and the capacitance, ESL, and self-resonant frequency thereof were calculated by simulations. The parameters were the same as those of the thin film capacitor of Example 1 except that the internal electrode layer 11 was divided into two. The area of one of the divided two internal electrode layers 11 was 0.275 mm², and the area of the other one thereof was 0.01 mm². As shown in FIG. 12, the capacitance of the thin film capacitor of Example 10 was 135.3 nF, the ESL thereof was 4.7 pH, and the self-resonant frequency thereof was 252 MHz. Thus, the thin film capacitor of Example 10 was smaller in ESL and higher in self-resonant frequency than the thin film capacitor of Example 1.

There was assumed a thin film capacitor of Example having the structure illustrated in FIG. 6, and the capacitance, ESL, and self-resonant frequency thereof were calculated by simulations. The parameters were the same as those of the thin film capacitor of Example 1 except that a material having a dielectric constant 6 of 500 was used for the dielectric layer 21. As shown in FIG. 12, the capacitance of the thin film capacitor of Example 11 was 127 nF, the ESL thereof was 5.7 pH, and the self-resonant frequency thereof was 240 MHz. Thus, the thin film capacitor of Example 11 was smaller in ESL and higher in self-resonant frequency than the thin film capacitor of Example 1.

There was assumed a thin film capacitor of Example having the structure illustrated in FIG. 9, and the capacitance, ESL, and self-resonant frequency thereof were calculated by simulations. The parameters were the same as those of the thin film capacitor of Example 1 except that the distances W11 and W12 were zero, the distances W12 and W16 were 200 μm, and the distances W17 and W18 were 300 μm. As shown in FIG. 12, the capacitance of the thin film capacitor of Example 12 was 136.8 nF, the ESL thereof was 4 pH, and the self-resonant frequency thereof was 210 MHz. Thus, the thin film capacitor of Example 12 was smaller in ESL and higher in self-resonant frequency than the thin film capacitor of Example 1.

There was assumed a thin film capacitor of Example in which the numbers of the via conductors 31 and 32 were each seven, the distances W3 and W4 were 264.76 μm, the distances W5 to W8 were 389.49 μm, the distances W13 and W14 were 150 μm, and the distances W15 to W18 were 275 μm, and the capacitance, ESL, and self-resonant frequency thereof were calculated by simulations. The other parameters were the same as those of the thin film capacitor of Example 1. As shown in FIG. 12, the capacitance of the thin film capacitor of Example 13 was 150 nF, the ESL thereof was 1.8 pH, and the self-resonant frequency thereof was 310 MHz. Thus, the thin film capacitor of Example 13 was smaller in ESL and higher in self-resonant frequency than the thin film capacitor of Example 1.

There was assumed a thin film capacitor of Example having the same structure as that of the thin film capacitor of Example 13 except that the internal electrode layer 11 was divided into two, and the capacitance, ESL, and self-resonant frequency thereof were calculated by simulations. The area of one of the divided two internal electrode layers 11 was 0.275 mm², and the area of the other one thereof was 0.01 mm². As shown in FIG. 12, the capacitance of the thin film capacitor of Example 14 was 146.1 nF, the ESL thereof was 1.8 pH, and the self-resonant frequency thereof was 314 MHz. Thus, the thin film capacitor of Example 14 was higher in self-resonant frequency than the thin film capacitor of Example 13.

There was assumed a thin film capacitor of Example 15 having the same structure as the thin film capacitor of Example 14 except that the wiring patterns 41 and 42 were each partially formed as a meander-shaped detouring part, and the capacitance, ESL, and self-resonant frequency thereof were calculated by simulations. The maximum detouring distance of the detouring part was 1160 μm. As shown in FIG. 12, the capacitance of the thin film capacitor of Example 15 was 144.3 nF, the ESL thereof was 0.1 pH, and the self-resonant frequency thereof was 1340 MHz. Thus, the thin film capacitor of Example 15 was significantly smaller in ESL and significantly higher in self-resonant frequency than the thin film capacitor of Example 14.

### REFERENCE SIGNS LIST

2 substrate
4 capacitor layer
11-18 internal electrode layer
21-27 dielectric layer
31-38 via conductor
40 redistribution layer
41, 42, 42A, 42B wiring pattern
51, 52, 52A, 52B external terminal
61, 62 via conductor
71 power supply line
72 ground line
73 power supply circuit
74 CPU
C1-C7 capacitor
L1-L7 parasitic inductance
R1-R7 parasitic resistance
V power supply potential

1. A thin film capacitor comprising:
a capacitor layer having a structure in which a plurality of internal electrode layers and a plurality of dielectric layers are alternately stacked;
a redistribution layer stacked on the capacitor layer; and
first and second external terminals,
wherein the plurality of internal electrode layers include a plurality of odd-numbered electrode layers including at least first and third internal electrode layers and a plurality of even-numbered electrode layers including at least second and fourth internal electrode layers,
wherein the first, second, third, and fourth internal electrode layers are stacked in this order through the plurality of dielectric layers,
wherein the redistribution layer includes a first wiring pattern connecting the first external terminal and the odd-numbered electrode layers and a second wiring pattern connecting the second external terminal and the even-numbered electrode layers,
wherein the first and third internal electrode layers are connected to the first wiring pattern respectively through first and third via conductors,
wherein the second and fourth internal electrode layers are connected to the second wiring pattern respectively through second and fourth via conductors, and
wherein a distance between the first and second via conductors is smaller than a distance between the second and third via conductors and is smaller than a distance between the first and fourth via conductors.

2. The thin film capacitor as claimed in claim 1, wherein a diameter of at least one of the first and second via conductors is larger than diameters of the third and fourth via conductors.

3. The thin film capacitor as claimed in claim 1, wherein a number of at least one of the first and second via conductors is larger than numbers of the third and fourth via conductors.

4. The thin film capacitor as claimed in claim 1, wherein an outer size of the first internal electrode layer is smaller than outer sizes of the second to fourth internal electrode layers.

5. The thin film capacitor as claimed in claim 1,
wherein the first internal electrode layer is divided into a plurality of areas, and
wherein the first via conductor is assigned to each of the plurality of areas.

6. The thin film capacitor as claimed in claim 1, wherein, among the plurality of dielectric layers, the dielectric layer positioned between the first and second internal electrode layers is lower in dielectric constant than the dielectric layer positioned between the second and third internal electrode layers and the dielectric layer positioned between the third and fourth internal electrode layers.

7. The thin film capacitor as claimed in claim 1,
wherein the first and second wiring patterns are connected to the first and second external terminals respectively through fifth and sixth via conductors,
wherein a distance between the first and fifth via conductors is smaller than a distance between the third and fifth via conductors, and
wherein a distance between the second and sixth via conductors is smaller than a distance between the fourth and sixth via conductors.

8. The thin film capacitor as claimed in claim 1,
wherein the plurality of odd-numbered electrode layers further includes a fifth internal electrode layer,
wherein the plurality of even-numbered electrode layers further includes a sixth internal electrode layer,
wherein the fifth, sixth, first, second, third, and fourth internal electrode layers are stacked in this order through the plurality of dielectric layers,
wherein the fifth internal electrode layer is connected to the first wiring pattern through the fifth via conductor, and
wherein the sixth internal electrode layer is connected to the second wiring pattern through the sixth via conductor.

9. The thin film capacitor as claimed in claim 1, wherein one of the first and second external terminals is a single terminal, and another one thereof is divided into a plurality of terminals.

10. The thin film capacitor as claimed in claim 1,
wherein the first wiring pattern has a first connection part connected to the first via conductor, a third connection part connected to the third via conductor, and a first detouring part connecting the first and third connection parts through a non-shortest route, and
wherein the second wiring pattern has a second connection part connected to the second via conductor, a fourth connection part connected to the fourth via conductor, and a second detouring part connecting the second and fourth connection parts through a non-shortest route.

11. The thin film capacitor as claimed in claim 10, wherein at least one of the first and second detouring parts has a meander shape.

12. An electronic circuit module comprising:
a circuit board; and
the thin film capacitor as claimed in claim 1 mounted on the circuit board.

13. The thin film capacitor as claimed in claim 2, wherein a number of at least one of the first and second via conductors is larger than numbers of the third and fourth via conductors.
